(19) United States
(12) Patent Application Publication
(10) Pub. No.: US 2016/0149208 A1
(43) Pub. Date: May 26, 2016

(54) ELECTRODE FOR SECONDARY BATTERY

(71) Applicant: TOYOTA JIDOSHA KABUSHIKI KAISHA, Toyota-shi, Aichi-ken (JP)

(72) Inventor: Kazuhiro SUZUKI, Toyota-shi, Aichi-ken (JP)

(73) Assignee: TOYOTA JIDOSHA KABUSHIKI KAISHA, Toyota-shi, Aichi-ken (JP)

(21) Appl. No.: 14/900,167

(22) PCT Filed: Jun. 17, 2014
(86) PCT No.: PCT/IB2014/001094

§ 371 Date: Dec. 20, 2015

(30) Foreign Application Priority Data
Jun. 28, 2013 (JP) 2013-137330

(51) Int. Cl. H01M 4/36; H01M 4/04

(52) U.S. Cl. CPC H01M 4/366; H01M 4/0404

(57) ABSTRACT

An electrode for secondary batteries, the electrode includes a current collector foil, a first mixture layer, and a second mixture layer. The first mixture layer is a layer of granulated particles accumulated on the current collector foil. The granulated particles contain at least an active material and a binder. The second mixture layer is a layer of a mixture paste applied to a surface of the first mixture layer and then dried. The mixture paste is obtained by kneading at least an active material, a binder, and a solvent.

### BACKGROUND OF THE INVENTION

1. Field of the Invention

The invention relates to an electrode for secondary batteries.

2. Description of Related Art

Hitherto, electrodes for secondary batteries such as lithium-ion batteries and nickel-hydrogen batteries have been produced by applying a pasty mixture containing an active material, a binder, etc. to a surface of a current collector foil and drying the pasty mixture. See, for example, Japanese Patent Application Publication No. 2011-187343 (JP 2011-187343 A).

JP 2011-187343 A discloses an electrode for secondary batteries which includes a mixture layer formed on the current collector (current collector foil) in the following manner in order to inhibit binder segregation in the electrode. The electrode is obtained by imparting a binder-trapping liquid capable of trapping a binder to a surface of a current collector, applying a mixture paste containing an active material and a binder to the current-collector, surface coated with the binder-trapping liquid, and then drying the mixture paste.

In particular, the electrode of JP 2011-187343 A is an electrode produced by applying a mixture paste to a current collector foil (hereinafter, this electrode is referred to also as coated type electrode). In the case of such electrodes, there is a possibility that, if the resistance is reduced in order to improve the battery performance and the specific surface area of the active material is increased and the number of reaction sites is increased in order to improve the output, then the cycling characteristics (life) might deteriorate.

Meanwhile, in the case of electrodes produced by powder molding, it is possible to reduce the resistance because the penetrability by an electrolytic solution, the orientation of the negative active material, and the dispersibility of the positive-electrode conductive material are better due to the electrode structure. However, it has been found that in case where the negative electrode has, for example, unevenness in the mixture-layer loading, this results in a deterioration in cycling characteristics. For diminishing the unevenness in mixture-layer loading, it is necessary to control the flowability of the granulated particles and to precisely stack the particles on a current collector foil. Namely, for precisely stack granulated particles on a current collector foil, it is necessary to improve the flowability of the particles. However, an improvement in particle flowability is prone to impair the adhesion among the particles, resulting in a decrease in the resistance-reducing effect of the powder molding. Consequently, it becomes a factor in causing a decrease in battery performance.

Specifically, in cases when an electrode of a lithium-ion secondary battery has unevenness in mixture-layer loading, the reactions during charge/discharge do not evenly take place over the whole electrode but concentrate in the part where the mixture-layer loading is smaller than the other part. In a cycle test for evaluating the cycling characteristics of a secondary battery, since a charge/discharge cycle is repeated, lithium deposits mainly on the portion where the reactions concentrate, i.e. on the part where the mixture-layer loading is smaller than the other part. For example, the part of the negative electrode where the mixture-layer loading is smaller than the other part may be unable to receive all the lithium discharged from the positive electrode as the counter electrode. That is, the capacity ratio, which is the capacity ratio of the negative electrode to the positive electrode, is below 1.0. This also promotes lithium deposition. Consequently, in the cycle test, electrodes produced by powder molding are more prone to deteriorate than the coated type electrodes and may result in a decrease in capacity retention. Thus, among the characteristics of a lithium-ion secondary battery, output and life have a trade-off relationship therebetween in many cases.

### SUMMARY OF THE INVENTION

The invention provides an electrode for secondary batteries, the electrode which reduces resistance and improves cycling characteristics.

Namely, the electrode for secondary batteries, the electrode which is a first aspect of the invention, includes a current collector foil, a first mixture layer, and a second mixture layer. The first mixture layer is a layer of granulated particles accumulated on the current collector foil. The granulated particles contain at least an active material and a binder. The second mixture layer is a layer of a mixture paste applied to the surface of the first mixture layer and then dried. The mixture paste is obtained by kneading at least an active material, a binder, and a solvent.

In the electrode for secondary batteries that has the configuration described above, by forming a molded-powder layer as the lower layer of the electrode mixture layer, the penetrability by electrolytic solutions, orientation of the negative active material, and dispersibility of the positive-electrode conductive material are improved and, hence, a reduction in resistance is attained. Furthermore, by forming a mixture paste layer as the upper layer of the electrode mixture layer, the unevenness in mixture-layer loading in the electrode can be diminished as compared with the electrode mixture layer which consisted only by the molded powder layer. Therefore, the cycling characteristics of the secondary batteries can be improved.

In the electrode for secondary batteries, the electrode which is the first aspect of the invention, the loading of the first mixture layer may be larger than the loading of the second mixture layer.

In the electrode for secondary batteries that has the configuration described above, by increasing the loading of the mixture layer formed by powder molding, the amount of the paste to be applied can be reduced, and the amount of the solvent to be used for paste application and the drying time can be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram which schematically shows an apparatus for producing an electrode for secondary batteries according to one embodiment of the invention;

FIG. 2 is a diagram which shows an image of a cross-sectional structure of an electrode (electrode sheet) for secondary batteries according to one embodiment of the invention;

FIG. 3 is a flow diagram of a process, according to one embodiment of the invention, for producing an electrode for secondary batteries;

FIG. 4 is a graph in which batteries for evaluation according to Example and Comparative Examples 1 and 2 are compared in initial IV resistance; and

FIG. 5 is a graph in which the batteries for evaluation according to Example and Comparative Examples 1 and 2 are compared in capacity retention after a cycle test.

### DETAILED DESCRIPTION OF EMBODIMENTS

Next, embodiments of the invention will be explained. The electrode for secondary batteries according to the following embodiment is usable as the electrodes (electrode sheets) possessed by nonaqueous-electrolyte secondary batteries.

First, the invention will be explained by reference to a lithium-ion secondary battery as one example of nonaqueous-electrolyte secondary batteries equipped with the electrode for secondary batteries according to the following embodiment.

The lithium-ion secondary battery (not shown) is configured, for example, as a cylindrical battery, prismatic battery, or laminate type battery obtained by disposing, in a battery housing, an electrode assembly which includes a sheet-shaped positive electrode (positive-electrode sheet) and a sheet-shaped negative electrode (negative-electrode sheet) and which is in a superposed or wound state. Specifically, a positive electrode and a negative electrode which have been produced in a sheet form are stacked, together with a separator interposed therebetween, for example by superposing or spirally winding the sheets, thereby forming an electrode assembly. This electrode assembly is housed inside a battery housing, which in this state is filled with an electrolytic solution and is then hermetically sealed. The thus-produced lithium-ion secondary battery is equipped with an electrode assembly including a positive electrode, a negative electrode, a separator, etc. and with a battery housing that houses the electrode assembly therein, and employs a nonaqueous electrolytic solution as the electrolytic solution.

The positive electrode (positive-electrode sheet) is a positive electrode obtained by forming, over a current collector foil, an electrode mixture layer which includes electrode materials including a positive active material capable of occluding/releasing lithium ions, a conductive material, a binder, a thickener, etc. The positive electrode (positive-electrode sheet) may be the electrode for secondary batteries according to this embodiment.

As the positive active material, use can be made of a positive active material such as a lithium-transition metal composite oxide. Examples of the positive active material include LiCoO₂, LiNiO₂, LiMn₂O₄, and such lithium-transition metal composite oxides in which the constituent elements have been partly replaced with other element(s).

The conductive material is for ensuring the electrical conductivity of the positive electrode. As the conductive material, use can be made of a carbonaceous powdery material such as natural graphite, an artificial graphite, acetylene black (AB), or carbon black.

The negative electrode (negative-electrode sheet) is obtained by forming an electrode mixture layer on a current collector foil. The electrode mixture layer includes electrode materials including a negative active material capable of occluding lithium ions during charge and of releasing the lithium ions during discharge, a binder, a thickener, etc. The negative electrode (negative-electrode sheet) may be the electrode for secondary batteries according to this embodiment.

The negative electrode is not particularly limited so long as use can be made of a negative active material having the property of occluding lithium ions during charge and of releasing the lithium ions during discharge. Examples of the material having such property include lithium metal and carbon materials such as graphites and amorphous carbon. Preferred among these are carbon materials that bring about relatively large voltage changes with the occlusion/release of lithium ions. It is more preferred to use a highly crystalline carbon material constituted of natural graphite, an artificial graphite, or the like.

The binder serves to bind the particles of the positive active material and conductive material together or the particles of the negative active material together to prevent these particles from separating. The binder further serves to bind these particles to the current collector foil. A fluororesin can be used as the binder. The fluororesin is, for example polytetrafluoroethylene (PTFE), polyvinylidenefluoride (PVDF), a styrene/butadiene copolymer (SBR), or a fluororubber or a thermoplastic resin such as polypropylene.

The thickener is for imparting viscosity to an electrode mixture paste (positive-electrode mixture paste or negative-electrode mixture paste). As the thickener, use may be made, for example, of poly(ethylene oxide) (PEO), poly(vinyl alcohol) (PVA), or carboxymethyl cellulose (CMC). Incidentally, the thickener is used in cases when the electrode mixture paste is required to have viscosity, and may be used, as appropriate, according to need.

The separator is for electrically insulating the positive electrode and the negative electrode from each other and for holding the nonaqueous electrolytic solution therein. Examples of the material constituting the separator include porous synthetic-resin films, in particular, porous films of polyolefin polymers (polyethylene and polypropylene), etc.

As the electrolytic solution, use can be made of a solution obtained by dissolving a lithium salt, such as LiPF₆, LiClO₄, or LiBF₄, as a supporting electrolyte in a mixed organic solvent composed of a cyclic carbonate such as ethylene carbonate (EC), propylene carbonate (PC), or vinylene carbonate (VC) and a chain carbonate such as dimethyl carbonate (DMC), diethyl carbonate (DEC), or ethyl methyl carbonate (EMC).

The positive electrode (positive-electrode sheet) and negative electrode (negative-electrode sheet) described above are superposed, wound, or otherwise disposed, with a separator interposed therebetween, thereby forming an electrode assembly. The positive electrode and negative electrode in the assembly are electrically connected respectively to a positive-electrode terminal and a negative-electrode terminal which are for external connection, and this electrode assembly is housed inside an appropriate battery housing. The space between the positive electrode and the negative electrode is filled with a nonaqueous electrolytic solution, and the battery housing is hermetically sealed. Thus, a lithium-ion secondary battery is configured. Examples of the battery housing include a case made of a metal or resin and a bag constituted of a laminated film made of a metal such as aluminum.

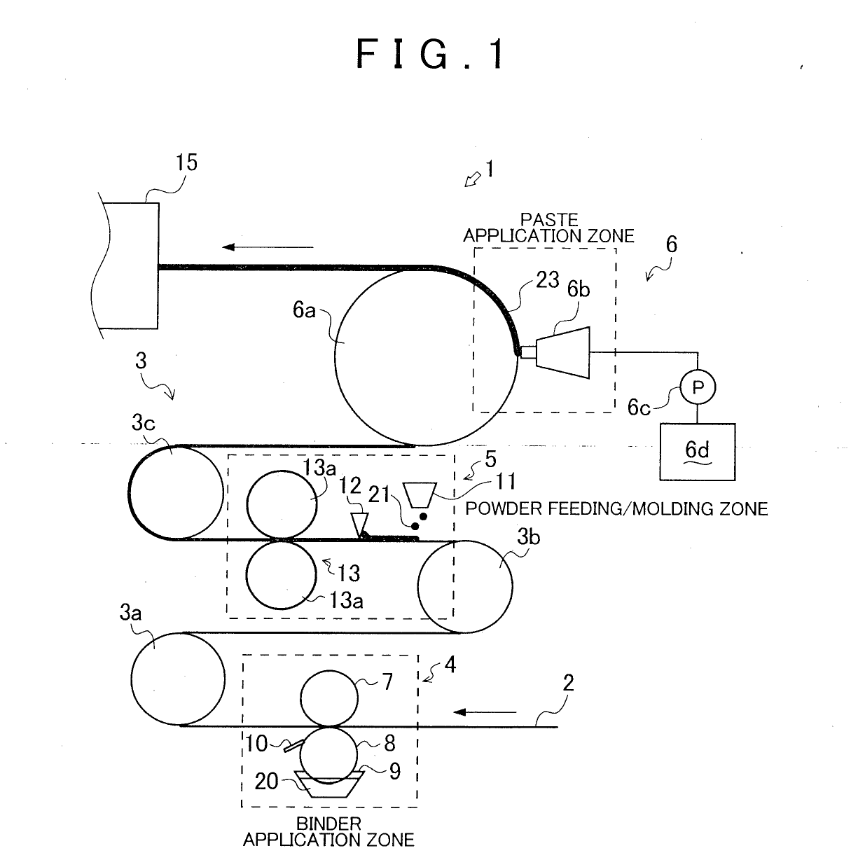

Next, a production apparatus 1 for producing the electrode for secondary batteries according to this embodiment is explained using FIG. 1.

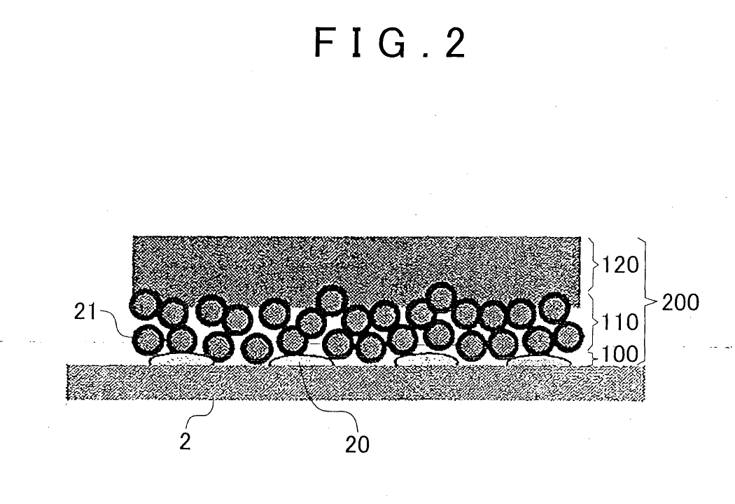

The production apparatus 1 for the electrode for secondary batteries according to this embodiment (hereinafter, referred to as production apparatus 1) is an apparatus for forming an electrode mixture layer 200 composed of three layers (see FIG. 2) on a current collector foil 2 by successively conducting the following four steps while conveying the current collector foil 2: applying a binder 20 to the current collector foil 2; feeding and molding a powder composed of granulated particles 21; applying an electrode mixture paste 23; and drying the electrode mixture paste 23. The three layers are a binder layer 100, a molded-powder layer 110 which is a first mixture layer, and a mixture paste layer 120 which is a second mixture layer. The production apparatus 1 is configured mainly of a conveyor 3, a binder applicator 4, a powder molding device 5, a mixture paste applicator 6, and a drying oven 15 as a dryer, as shown in FIG. 1.

The current collector foil 2 is a sheet-shaped electrode base which is thin and continuous and is for use in producing electrodes for secondary batteries. The current collector foil 2 is a metal foil (e.g. an aluminum foil for the positive electrode or a copper foil for the negative electrode) on which a given electrode mixture layer 200 is to be formed on one side or each side thereof (on one side in this embodiment) by the production apparatus 1.

The conveyor 3 is a device for engaging the current collector foil 2, which is being fed from a feed roller that is a current-collector-foil feed part (not shown) disposed upstream from the conveyor 3, with a plurality of rollers and for conveying the current collector foil 2 at a given speed (2 m/min in this embodiment) to the binder applicator 4, powder molding device 5, mixture paste applicator 6, and drying oven 15 in this order. The conveyor 3 is configured mainly of a plurality of guide rollers 3a, 3b, and 3c, a backup roller 6a possessed by the mixture paste applicator 6, a feed roller (not shown) which is a current-collector-foil feed part, and a wind-up roller (not shown) which is a current-collector-foil winding part. The wind-up roller has been disposed downstream from the drying oven 15. As shown in FIG. 1, a current collector foil 2 is set in the conveyor 3 to thereby constitute a conveying path for the current collector foil 2. A given length of the current collector foil 2 has been wound on the feed roller beforehand, and the current collector foil 2 unwound from the feed roller runs on the plurality of guide rollers 3a, 3b, and 3c and is engaged with the peripheral surface of the backup roller 6a. The current collector foil 2 sent from the backup roller 6a passes through the drying oven 15 and is then wound on the wind-up roller. Thus, when the wind-up roller is rotated at a given speed by a driving device (not shown), then the current collector foil 2 wound on the feed roller is unwound therefrom and is conveyed first to the binder applicator 4, subsequently conveyed to the powder molding device 5 via, the guide rollers 3a and 3b, and then conveyed to the mixture paste applicator 6 via the guide roller 3c. The current collector foil 2 is conveyed while the back side thereof is being supported by the peripheral surface of the backup roller 6a, and is conveyed so as to face a die coater 6b. The current collector foil 2 which has passed through the mixture paste applicator 6 passes through the drying oven 15 and is then wound by the wind-up roller. Namely, by rotating the wind-up roller by the driving device (not shown), the conveyor 3 can be made to convey the current collector foil 2 along the conveying path at a given, speed to the binder applicator 4, powder molding device 5, mixture paste applicator 6, and drying oven 15 in this order.

The binder applicator 4 is a gravure coater which has been disposed upstream in the conveying path of the current collector foil 2 in the production apparatus 1 and with which a slurried binder 20 can be applied to one side (front surface) of the current collector foil 2 in a predetermined loading. The binder applicator 4 includes a rotatable press-bonding roller 7, a gravure roller 8 to be pressed against the press-bonding roller 7 through the current collector foil 2, a reservoir tray 9 for reserving the binder 20, and a blade 10. The binder applicator 4 can apply a slurried binder 20 to one side (front surface) of the current collector foil 2 sent from the feed roller (not shown), by means of the press-bonding roller 7 and the gravure roller 8.

Specifically, part (lower part) of the gravure roller 8, which has been disposed on the lower side of the current collector foil 2 being conveyed along the conveying path, is immersed in the binder 20 inside the reservoir tray 9, and the binder 20 is applied to one side (front surface) of the current collector foil 2. The press-bonding roller 7 has been disposed on the upper side of the current collector foil 2 so that part (lower part) thereof is pressed against the other side (back surface) of the current collector foil 2. The gravure roller 8 bears a so-called given gravure pattern on the peripheral surface thereof; and the gravure pattern has been formed by given engraving. The gravure roller 8 rotates in the direction opposite from the conveying direction of the current collector foil 2 by means of a driving device (not shown). As the gravure roller 8 rotates, the binder 20 inside the reservoir tray 9 adheres to the peripheral surface of the gravure roller 8, and the binder 20 which has adhered to the gravure roller 8 is partly scraped off by the blade 10 so that the binder 20 remains adherent thereto in a given amount. The gravure roller 8 having the binder 20 adherent in the given amount to the peripheral surface thereof is pressed against one side (front surface) of the current collector foil 2, thereby applying (pattern-wise applying) the binder 20 to the side (front surface) of the current collector foil 2 in a given amount so as to form a given pattern. Thus, with the binder applicator 4, a binder layer (binder coat) 100 is formed on one side (front surface) of the current collector foil 2. In the electrode (electrode sheet) according to this embodiment, the binder layer 100 formed by the binder applicator 4 constitutes the lowermost layer of the electrode mixture layer 200, as will be described later in detail.

The powder molding device 5 has been disposed downstream from the binder applicator 4 in the conveying path of the current collector foil 2 guided by the guide roller 3b and the guide roller 3c. The powder molding device 5 is a device that continuously feeds granulated particles 21, which are a powdery electrode mixture, to the current collector foil 2 which is being Conveyed along the conveying path and that press-form (compression-form) the current collector foil 2 to which the granulated particles 21 have been fed, thereby forming a molded-powder layer 110 composed of the granulated particles 21. The powder molding device 5 is configured mainly of a powder feeder 11, a flattening device (squeegee 12), and a molding device 13, as shown in FIG. 1. The granulated particles 21, which are a powdery electrode mixture, are formed by the spray dryer (not shown) which will be described later. Although the powder molding device 5 according to this embodiment has a configuration including a flattening device, the powder molding device is not particularly limited to the configuration according to this embodiment. Namely, the flattening device of the powder molding device 5 is not essential.

The powder feeder 11 is a device which feeds the granulated particles 21, which are a powdery electrode mixture, to the current collector foil 2 and which forms the fed granulated particles 21 into a stack layer on the current collector foil 2. The powder feeder 11 is capable of continuously feeding a powder of granulated particles 21 at a constant rate to the surface of the current collector foil 2 and stacking the granulated particles 21 on the current collector foil 2.

The conveyor 3 is a device for conveying the current collector foil 2 to the powder feeder 11, squeegee 12, and molding device 13 in this order in the powder molding device 5. By driving the driving device (not shown), the conveyor 3 can be made to convey downstream the granulated particles 21 fed to the current collector foil 2 from the powder feeder 11.

The squeegee 12 is a blade member which has been disposed downstream from the powder feeder 11 and has a sharp edge, the squeegee 12 having been disposed and affixed so that the edge points downward and that the space between the edge and the surface of the current collector foil 2 has a given gap. The squeegee 12 is a device for flattening the granulated particles 21 fed to the surface of the current collector foil 2 by the powder feeder 11 and for thereby forming a stack layer which is composed of a powder of the granulated particles 21 and has a thickness of the same dimension as the given gap.

The molding device 13 is a press-molding device of a roll type disposed downstream from the squeegee 12 and has a plurality of rotatable press rollers 13a and 13a. In this embodiment, the press rollers 13a and 13a are two pressing rollers arranged vertically. With the molding device 13, the current collector foil 2 having, formed thereon, the stack layer of the granulated particles 21 can be heated and pressed in the current-collector-foil thickness direction by inserting the current collector foil 2 between the vertically arranged two press rollers 13a and 13a. The so-called roll pressing is possible. Specifically, in the molding device 13, the current collector foil 2 having, formed thereon, the powder stack layer composed of the granulated particles 21 is roll-pressed under given hot pressing conditions (heating temperature, pressing pressure) while the current collector foil 2 is being sandwiched between the press rollers 13a and 13a and the press rollers 13a and 13a are being rotated in the directions opposite to each other. Thus, it is possible to form a molded-powder layer 110 having a thickness and a density (electrode density) which have been suitably regulated, on the current collector foil 2 to be discharged from the downstream end of the molding device 13. In the electrode (electrode sheet) according to this embodiment, the molded-powder layer 110 formed by the powder molding device 5 constitutes the lower layer of the electrode mixture layer 200, as will be described later in detail. In this powder molding device 5, a powder of the granulated particles 21 is fed to and superposed on the surface of the binder layer 100 formed from the slurried binder 20 applied to the current collector foil 2 by the binder applicator 4, and is roll-pressed to thereby form the molded-powder layer 110 on the binder layer 100. Although the powder molding device 5 according to this embodiment has a configuration including a molding device 13 (hot press), the powder molding device is not particularly limited to the configuration according to this embodiment. Namely, the molding device 13 (hot press) of the powder molding device 5 is not essential.

The mixture paste applicator 6 is a device for applying an electrode mixture paste 23 which is a pasty electrode mixture including an electrode active material, a binder, a solvent, etc., on the molded-powder layer 110 (lower layer), which is composed of a powder of granulated particles 21 including an electrode active material and a binder. The mixture paste applicator 6 is configured mainly of a backup roller 6a, a die coater 6b, a pump 6c, and a tank 6d, as shown in FIG. 1. Although the mixture paste applicator 6 according to this embodiment has, a configuration including a die coater 6b, the mixture paste applicator is not particularly limited to the configuration according to this embodiment. Namely, the die coater 6b of the mixture paste applicator 6 is not essential.

The backup roller 6a has been disposed so as to face the die coater 6b and is a roller that supports the other side (back surface) of the current collector foil 2. The die coater 6b has an ejection opening that delivers the electrode mixture paste 23 to the current collector foil 2. The pump 6c is a pump that feeds the electrode mixture paste 23 to the die coater 6b from the tank 6d. The tank 6d is a container that reserves the electrode mixture paste 23.

When the mixture paste applicator 6 is operated, the electrode mixture paste 23 reserved in the tank 6d is first sucked up by the pump 6c. The electrode mixture paste 23 is then fed to the die coater 6b from the pump 6c and fed, through the ejection opening of the die coater 6b, to one side (front surface) of the current collector foil 2 supported by the backup roller 6a. In the mixture paste applicator 6, the electrode mixture paste 23 is fed to and superposed on the surface of the molded-powder layer 110 formed over the current collector foil 2 by the powder molding device 5. The die coater 6b can continuously apply the electrode mixture paste 23 to the current collector foil 2 that is moving along the peripheral surface of the backup roller 6a.

The current collector foil 2 coated with the electrode mixture paste 23 by the mixture paste applicator 6 is conveyed downstream from the mixture paste applicator 6 in the direction shown by the arrow, and is introduced into the drying oven 15. The current collector foil 2 coated with the electrode mixture paste 23 enters the inside of the drying oven 15 through the inlet of the drying oven 15. In the drying oven 15, hot air is blown against the current collector foil 2 coated with the electrode mixture paste 23, thereby vaporizing the solvent contained in the electrode mixture paste 23. Thus, the electrode mixture paste 23 can be dried.

The spray-drying device (not shown) is a device for obtaining granulated particles by spray-drying an electrode mixture paste produced using ingredients for an electrode mixture which include an electrode active material, a conductive material, a binder, etc. and using a solvent for dispersing the ingredients. Examples of such spray-drying device include a spray dryer that performs spray drying by the spray drying method. With the spray dryer, an electrode mixture paste can be instantly dried to obtain granulated particles. 21, by spraying the paste to form fine droplets thereof and bringing the droplets into contact with hot air.

Next, a process according to one embodiment of the invention for producing an electrode for secondary batteries using the production apparatus 1 described above is explained.

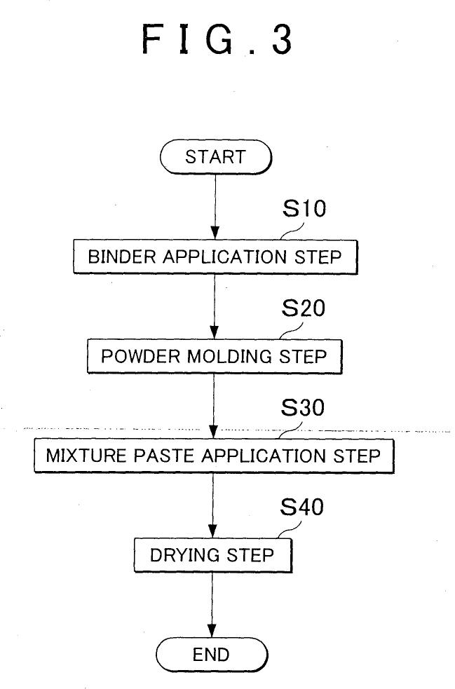

The process according to this embodiment for producing an electrode for secondary batteries is a process for producing a sheet-shaped electrode. The sheet-shaped electrode includes a current collector foil 2 and, formed thereon, a binder layer 100 made of a binder 20, a molded-powder layer 110, and a mixture paste layer 120. The molded-powder layer 110 is formed on the binder layer 100 and composed of granulated particles 21. The mixture paste layer 120 is a pasty electrode mixture containing an electrode active material and a binder, and the mixture paste layer 120 is obtained by applying the pasty electrode mixture to the surface of the molded-powder layer 110 and drying the pasty electrode mixture. This process for producing an electrode for secondary batteries mainly includes a binder application step S10, a powder molding step S20, a mixture paste application step S30, and a drying step S40 as shown in FIG. 3, the steps being conducted in this order. The process according to this embodiment for producing an electrode for secondary batteries is conducted using the production apparatus 1. In preparation for the production of an electrode for secondary batteries using the production apparatus 1, it is necessary to prepare, in advance, the granulated particles 21 and electrode mixture paste 23 to be fed to the production apparatus 1. So, first, a granulated-particle preparation step and an electrode-mixture-paste preparation step are explained as preparation steps for the process for producing an electrode for secondary batteries. The steps are specifically explained below.

The granulated-particle preparation step is configured of a paste production step and a granulation step.

The paste production step is a step in which an electrode mixture paste is produced using ingredients for an electrode mixture including an electrode active material, a conductive material, a binder, etc. and using a solvent for dispersing the ingredients therein, in a given ratio so as to result in a given solid content.

As the dispersion solvent, use can be made of organic solvents such as N-methyl-2-pyrrolidone (NMP), dimethylformamide (DMF), and dimethylacetamide (DMA) and water (purified water, etc.).

The granulation step is a step in which the electrode mixture paste obtained in the paste production step is used to form granulated particles 21. Specifically, the granulation step includes: using, for example, a spray dryer for spraying and thermal drying by the spray drying method to spray and thermally dry the electrode mixture paste and thereby obtain granulated particles; and disaggregating and classifying the granulated particles to produce granules that have given properties, such as particle diameter and bulk density, which are required of the granulated particles 21. Incidentally, the paste production step and granulation step described above are steps to be conducted in preparation for starting powder molding in the powder molding step S20. The step for preparing an electrode mixture paste 23, which is for use in the mixture paste applicator 6, is the same step as the paste production step, and an explanation thereof is hence omitted.

The binder application step S10 is a step in which a slurried binder 20 is applied by the binder applicator 4 to one side (front surface) of a current collector foil 2 in a predetermined loading. In this binder application step S10, a binder layer (binder coat) 100 is formed on one side (front surface) of the current collector foil 2, as shown in FIG. 2. The current collector foil 2 having the binder layer 100 formed by applying the slurried binder 20 in the binder, application step S10 is subsequently conveyed to the powder molding device 5.

The powder molding step S20 is a step in which the powder molding device 5 continuously feeds granulated particles 21 serving as a powdery electrode mixture to the current collector foil 2 that is being conveyed along the conveying path, and press-forms (compression-forms) the current collector foil 2 to which the granulated particles 21 have been fed, thereby forming a molded-powder layer 110, which is the lower layer of an electrode mixture layer 200. Specifically, in the powder molding step S20, granulated particles 21, which are a powdery electrode mixture including at least an electrode active material and a binder, are fed to and stacked on the surface of the binder 20 (binder, layer 100) applied to the current collector foil 2 in the binder application step S10, and thereafter the stacked particles are molded by hot pressing, thereby forming a molded-powder layer 110 composed of the granulated particles 21. The powder molding step S20 is a step conducted using the powder molding device 5 and is configured of a feeding step, a flattening step, and a molding step.

The feeding step is a step in which the powder of granulated particles 21 obtained in the granulation step is fed to the surface of the current collector foil 2 by the 15 powder feeder 11 possessed by the powder molding device 5, and the granulated particles 21 are disposed as a stack layer over the current collector foil 2.

The flattening step is a step in which the powder of granulated particles 21 fed to the surface of the current collector foil 2 by the powder feeder 11 is flattened using the squeegee 12 so that the surface of the powder becomes even, thereby forming a stack layer of the granulated particles 21 that has a thickness of the same dimension as the space between the edge of the squeegee 12 and the surface of the current collector foil 2, the space having a given gap.

The molding step is a step in which the current collector foil 2 having, over the surface thereof, the powder stack layer composed of the granulated particles 21 is hot-pressed by the molding device 13 under given hot pressing conditions (heating temperature, pressing pressure), that is, heated and simultaneously pressed in the thickness direction of the stack layer, thereby forming a molded-powder layer 110 that is thinner than the stack layer of the granulated particles 21. After completion of the molding step, the current collector foil 2 having the molded-powder layer 110 formed as the lower layer of the electrode mixture layer 200 is then conveyed to the mixture paste applicator 6.

The mixture paste application step S30 is a step in which by the mixture paste applicator 6, an electrode mixture paste 23 is applied to and superposed on the surface of the molded-powder layer 110 formed over the current collector foil 2 through the binder layer 100 in the powder molding step S20. The current collector foil 2 coated with the electrode mixture paste 23, which is pasty, in the mixture paste application step S30 is then conveyed to the drying oven 15.

The drying step S40 is a step in which the current collector foil 2 coated with the electrode mixture paste 23 in the mixture paste application step S30 is dried in the drying oven 15. In this drying step, the solvent contained in the electrode mixture paste 23 is volatilized and the electrode mixture paste 23 is dried, thereby forming a mixture paste layer 120. Thus, an electrode (electrode sheet) including a current collector foil 2 and, superposed thereon in the following order, a binder layer 100 serving as the lowermost layer of an electrode mixture layer 200, a molded-powder layer 110 serving as the lower layer thereof, and a mixture paste layer 120 serving as the upper layer thereof is produced by the process according to this embodiment for producing an electrode for secondary batteries.

The electrode for secondary batteries produced by the secondary-battery electrode production process described above according to this embodiment has an electrode structure such as the structure of an electrode mixture layer 200 shown in FIG. 2. The electrode mixture layer 200, which has been formed on a current collector foil 2, is configured of a binder layer 100 corresponding to the lowermost layer of the electrode mixture layer 200, a molded-powder layer 110 that has been disposed on the binder layer 100 and corresponds to the lower, layer (first mixture layer) of the electrode mixture layer 200, and a mixture paste layer 120 that has been disposed on the molded-powder layer 110 and corresponds to the upper layer (second mixture layer) of the electrode mixture layer 200.

The binder layer 100 is a layer portion of the electrode structure, the layer portion corresponding to the lowermost layer of the electrode mixture layer 200 and having been produced by pattern-wise applying a binder 20 to the surface of the current collector foil 2. The binder layer 100 is a layer disposed between the current collector foil 2 and the molded-powder layer 110, which corresponds to the lower layer of the electrode mixture layer 200, and is a layer made of a binder 20. The binder layer 100 is produced by applying a binder 20 in a given pattern (e.g. stripe pattern) by means of a gravure coater which is a binder applicator 4. The binder layer 100 is disposed in order to ensure the adhesion and electrical conduction between the molded-powder layer 110, which includes granulated particles 21, and the surface of the current collector foil 2. Although the electrode mixture layer 200 according to this embodiment has a configuration including a binder layer 100, the electrode mixture layer is not particularly limited to the configuration according to this embodiment. Namely, the binder layer 100 may be disposed, as appropriate, according to need, and is not essential to the electrode mixture layer 200.

The molded-powder layer 110 is a first mixture layer obtained by stacking granulated particles 21 constituted at least of an active material and a binder. Namely, the molded-powder layer 110 is the layer portion of the electrode structure which has been formed by powder molding over the current collector foil 2 and which corresponds to the lower layer (first mixture layer) of the electrode mixture layer 200. Here, the powder molding means an electrode production method which includes producing beforehand granulated particles which include an active material, stacking these granulated particles over a current collector foil 2, and pressing the stack.

The molded-powder layer 110 is a layer which has been disposed over the current collector foil 2 through the binder layer 100 and which is made of a powder of granulated particles 21 that include an electrode active material and a binder. The molded-powder layer 110 is a layer produced by powder molding from granulated particles 21 that are richer in binder than the mixture paste layer 120. Namely, the loading of the binder contained in the molded-powder layer 110 is larger than the loading of the binder contained in the mixture paste layer 120, which overlies the molded-powder layer 110. The binder content of the molded-powder layer 110 is preferably about 1.0 to 5.0 wt %. In the case of a negative electrode, the molded-powder layer 110 is formed by producing granulated particles which include an active material, a binder, and a thickener, stacking the granulated particles over a current collector foil 2, and pressing the stack. In the case of a positive electrode, the molded-powder layer 110 is formed by producing granulated particles which include an active material, a binder, a conductive material, and a dispersant, stacking the granulated particles over a current collector foil 2, and pressing the stack. By employing the configuration wherein the binder content of the molded-powder layer 110 is higher than the binder content of, the mixture paste layer 120, which overlies the molded-powder layer 110, as described above, the binder can be held more reliably in the vicinity of the current collector foil 2 and, hence, this electrode configuration is made to have improved peel strength between the current collector foil 2 and the electrode mixture layer 200. In this embodiment, although the binder constituting the binder layer 100 is the same as the binder contained in the granulated particles 21 used in the molded-powder layer 110, the binders are not particularly limited. Binders of different kinds may be also used.

The mixture paste layer 120 is a second mixture layer obtained by applying, to the surface of the molded-powder layer 110 serving as the first mixture layer, an electrode mixture paste 23 produced by kneading at least an active material, a binder, and a solvent and thereafter drying the electrode mixture paste. Namely, the mixture paste layer 120 is the layer portion of the electrode structure which has been formed by paste application on the surface of the molded-powder layer 110 serving as the first mixture layer and which corresponds to the upper layer (the second mixture layer) of the electrode mixture layer 200. The mixture paste layer 120 is a layer which has been formed, on the surface of the molded-powder layer 110 composed of the granulated particles 21, by applying and drying an electrode mixture paste 23, which is a pasty electrode mixture containing an electrode active material and a binder. A pressing step may be added according to need. In the case of a negative electrode, the mixture paste layer 120 is formed by producing a paste which contains an active material, a binder, and a thickener, applying the paste to the surface of the molded-powder layer 110, and drying the paste. According to need, a pressing step may be conducted after the drying. In the case of a positive electrode, the mixture paste layer 120 is formed by producing a paste which contains an active material, a binder, a conductive material, and a dispersant, applying the paste to the surface of the molded-powder layer 110, and drying the paste. According to need, a pressing step may be conducted after the drying. The mixture paste layer 120 is a layer formed by application of an electrode mixture paste 23 and so as to have a lower binder content than the molded-powder layer 110. The mixture paste layer 120 is made to have the configuration wherein the content of the binder is lower than the content of the binder of the molded-powder layer 110, which underlies the mixture paste layer 120. The binder content of the mixture paste layer 120 is preferably about 0.5 to 4.0 wt %.

In the electrode mixture layer 200, it is preferable that the weight ratio (mixture-layer loading ratio) of the two layers, i.e. the molded-powder layer 110 as the lower layer and the mixture paste layer 120 as the upper layer, be 10:90 to 90:10.

Incidentally, although the electrode mixture layer 200 in this embodiment has a, configuration including a binder layer 100 that corresponds to the lowermost layer, the configuration is not particularly limited. If the binder layer 100 is provided, the binder will thickly accumulate on the current collector foil 2 and ensure a peel strength of the electrode mixture layer 200. It is possible to omit the binder layer 100 as a constituent layer of the electrode mixture layer 200.

In the manner described above, an electrode for secondary batteries which has the electrode structure, i.e. the structure of an electrode mixture layer 200, can be produced. Next, a negative electrode (negative-electrode sheet) was produced as an Example of the electrode for secondary batteries in accordance with the process described above for producing an electrode for secondary batteries and using the production apparatus 1 and spray-drying device mentioned above, and this negative electrode was used to evaluate battery characteristics. The Example and Comparative Examples therefor are given below to explain the invention. Although a negative electrode is explained below as an example of the electrode for secondary batteries according to this embodiment, the electrode of the invention is not particularly limited. The configuration of the electrode for secondary batteries according to this embodiment can be applied also to positive electrodes (positive-electrode sheets).

In Example, first, three ingredients for an electrode mixture, i.e. a graphite as a negative active material, a binder constituted of an SBR, and CMC as a thickener, were mixed together in a given ratio, and this mixture was dispersed in water as a dispersion medium so as to result in a solid content of 50 wt %. According to the given ratio in this Example, the amount of the SBR was 5 wt % relative to all the electrode-mixture ingredients. These ingredients were kneaded using a kneading device (planetary mixer) to produce an electrode mixture paste for a granulation step. Incidentally, for an electrode mixture paste 23 to be used in the mixture paste applicator 6, 10, the same electrode-mixture ingredients and dispersion medium as those for the mixture paste produced in the above-described paste production step were used. However, the electrode mixture paste 23 was produced so that the amount of the SBR contained therein as a binder was 1 wt %. The procedure described above is a paste production step.

The electrode mixture paste obtained in the paste production step was subsequently sprayed in a furnace by the spray drying method using a spray dryer under given in furnace temperature conditions and was simultaneously dried with hot air to obtain granulated particles. These granulated particles were disaggregated and classified with a given appropriate device to thereby obtain granulated particles 21 having a desired average particle diameter and a desired particle diameter distribution. For the disaggregation of granulated particles, a conventional method using, for example, a ball mill can be used. The procedure described above is a granulation step.

Next, a slurried binder 20 (SBR in this Example) was applied to one side (front surface) of a current collector foil 2 by means of the binder applicator 4 in a predetermined loading. This procedure corresponds to the binder application step S10 shown in FIG. 3.

Subsequently, with the powder molding device 5, the granulated particles 21 serving as a powdery electrode mixture were continuously fed to the current collector foil 2 that was being conveyed along the conveying path, and the current collector foil 2 to which the granulated particles 21 had been fed was press-formed (compression-formed). Thus, a molded-powder layer 110, which was the lower layer of an electrode mixture layer 200, was formed. This procedure corresponds to the powder molding step S20 shown in FIG. 3.

The electrode mixture paste 23 was then applied to and superposed on the molded-powder layer 110 formed over the current collector foil 2 through the binder layer 100, by means of the mixture paste applicator 6. This procedure corresponds to the mixture paste application step S30 shown in FIG. 3.

Next, the current collector foil 2 coated with the electrode mixture paste 23 was passed through the drying oven 15 to dry the electrode mixture paste 23. This procedure corresponds to the drying step S40 shown in FIG. 3. Thus, a negative electrode (negative-electrode sheet) according to Example which was configured of a current collector foil 2 and, superposed thereon in the following order, a binder layer 100 as the lowermost layer of an electrode mixture layer 200, a molded-powder layer 110 as the lower layer (first mixture layer) thereof, and a mixture paste layer 120 as the upper layer (second mixture layer) thereof was produced by the process according to this embodiment for producing an electrode for secondary batteries. This negative electrode was produced so that the loading of the molded-powder layer 110 was 80% of a target mixture-layer loading and that the loading of the mixture paste layer 120 was 20% thereof. Namely, the negative electrode was produced so that the weight ratio (loading ratio) of the molded-powder layer 110 to the mixture paste layer 120 was 80:20. By thus making the loading of the molded-powder layer 110 as the first mixture layer larger than the loading of the mixture paste layer 120 as the second mixture layer, the amount of the paste to be applied can be reduced and the solvent amount and, drying time necessary for paste application can be reduced. Thereafter, the negative electrode (negative-electrode sheet) according to Example and a given positive electrode (positive-electrode sheet) prepared beforehand were cut into respective sizes so as to result in a given value of battery design capacity, and the negative electrode and the positive electrode were then disposed so as to face each other through a separator, thereby forming an electrode assembly. Furthermore, the electrode assembly was introduced into a container together with an electrolytic solution, and the container was sealed by laminating, thereby obtaining a lithium-ion secondary battery of the laminate cell type. Thus, a battery for evaluation according to Example was produced. The given positive electrode was one produced by a conventional production process by applying an electrode mixture paste to a current collector foil (aluminum foil) and drying the paste. The electrode mixture paste was produced by mixing three ingredients for an electrode mixture, i.e. a positive active material, a conductive material constituted of AB, and a binder constituted of PVDF, in a given weight ratio and dispersing the mixture in a given dispersion medium. The positive active material in this Example was a lithium-containing ternary composite oxide composed of a nickel-lithium composite oxide (LiNiO₂), a manganese-lithium composite oxide (LiMnO₂), and a cobalt-lithium composite oxide (LiCoO₂). The given dispersion medium in this Example was NMP.

In Comparative Example 1 was prepared a battery for evaluation which was equipped with an electrode (coated type electrode) having an electrode mixture layer formed merely by application of a mixture paste. The negative electrode according to Comparative Example 1 was produced in the following manner. The same ingredients for an electrode mixture as in Example were mixed together in a given ratio, and the mixture was dispersed in water as a dispersion medium so as to result in a solid content of 50 wt %. These ingredients were kneaded using a kneading device (planetary mixer) to produce an electrode mixture paste. This electrode mixture paste was applied, in the paste state, to a surface of a current collector foil and dried. The negative electrode according to Comparative Example 1 was one in which the electrode mixture layer on the current collector foil had a single-layer structure obtained by applying and drying the electrode mixture paste. Furthermore, the negative electrode according to Comparative Example 1 was one which contained the same binder in the same amount as the negative electrode according to Example. As the positive electrode, use was made of the same positive electrode as in Example. Using the negative electrode and the positive electrode, a battery for evaluation according to Comparative Example 1 was produced in the same manner as in Example.

In Comparative Example 2 was prepared a battery for evaluation which was equipped with an electrode having an electrode mixture layer formed merely by the powder molding of granulated particles. The negative electrode according to Comparative Example 2 was produced in the following manner. The same ingredients for an electrode mixture as in Example were mixed together in a given ratio, and the mixture was dispersed in water as a dispersion medium so as to result in a solid content of 50 wt %. These ingredients were kneaded using a kneading device (planetary mixer) to produce an electrode mixture paste. This electrode mixture paste was used to produce granulated particles by the spray drying method. The granulated particles were fed to a surface of a current collector foil, and an electrode mixture layer was formed therefrom on the current collector foil by powder molding. The negative electrode according to Comparative Example 2 was one in which the electrode mixture layer on the current collector foil had a single-layer structure obtained by the powder molding of granulated particles. Furthermore, the negative electrode according to Comparative Example 2 was one which contained the same binder in the same amount as the negative electrode according to Example. As the positive electrode, use was made of the same positive electrode as in Example. Using the negative electrode and the positive electrode, a battery for evaluation according to Comparative Example 2 was produced in the same manner as in Example. The batteries for evaluation according to Example and Comparative Examples 1 and 2, which had been produced by the methods described above, were used to evaluate initial IV resistance and cycling characteristics.

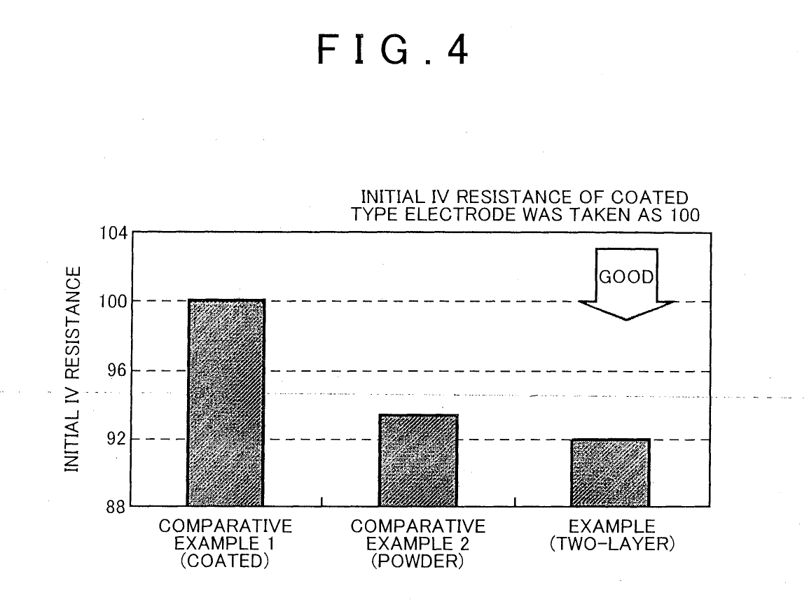

First, evaluation of initial IV resistance is described. Each of the batteries for evaluation which was in a discharged state was charged at a constant current of ⅕ C in a quantity corresponding to 60% of the initial capacity, thereby regulating the state of charge (SOC) of each battery for evaluation to 60%. In the battery having an SOC of 60%, a constant current of ⅓ C, 1 C, or 3 C was caused to flow for 5 seconds, and the overvoltages during the charge and discharge were measured. These measured values were divided by the corresponding current values to calculate resistance values, the average of which was taken as initial direct-current resistance. All the operations described above were conducted in a 25° C. environment. The results thereof are shown in FIG. 4. FIG. 4 shows the results in which the value of initial IV resistance of the battery for evaluation according to Comparative Example 1 was taken as 100. It was seen, as shown in FIG. 4, that the battery for evaluation according to Example had reduced resistance as compared with the batteries for evaluation according to Comparative Examples 1 and 2. It was understood from the results that the battery for evaluation according to Example had satisfactory battery performance with reduced battery resistance as compared with the batteries for evaluation according to Comparative Examples 1 and 2.

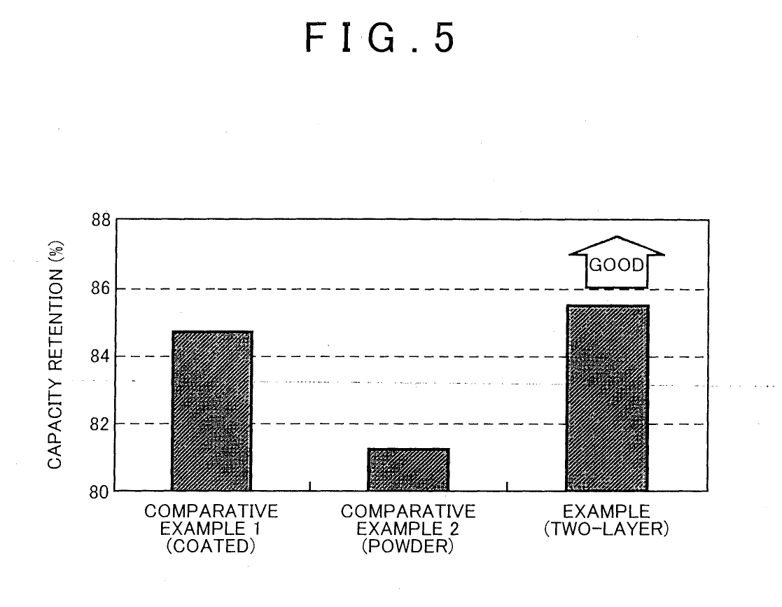

Next, evaluation of cycling characteristics is described. At an ambient temperature of 60° C., each of the batteries for evaluation was charged to 4.1 V at a constant charge rate of 2 C and then discharged to 3.0 V at the discharge rate of 2 C. This charge/discharge cycle as one cycle was repeated to conduct 200 cycles. Thereafter, the discharge capacity of this battery was determined in the same manner as for the initial capacity; this discharge capacity is referred to as after-cycling discharge capacity. By dividing the after-cycling discharge capacity by the initial capacity, a capacity retention [%] was calculated. Thus, the batteries for evaluation according to Example and Comparative Examples 1 and 2 were subjected to the cycle test. As shown in FIG. 5, the battery for evaluation according to Example showed satisfactory cycling characteristics as compared with the batteries for evaluation according to Comparative Examples 1 and 2. A comparison between Comparative Example 1 (coated type electrode) and Comparative Example 2 (electrode produced through powder molding) in the initial IV resistance shown in FIG. 4 indicates that Comparative Example 2 (electrode produced through powder molding) exhibited a resistance-reducing effect. However, Comparative Example 2 (electrode produced through powder molding) had a low capacity retention after the cycle test as shown in FIG. 5 and was insufficient in terms of battery characteristics. As demonstrated above, the battery for evaluation according to Example was able to have a capacity retention improved to a level not lower than that of the battery for evaluation according to Comparative Example 1, which employed a coated type electrode, while retaining the merit of being low in initial IV resistance.

The invention has a feature wherein an electrode is produced so as to have a two-layer structure, i.e. produced by forming an upper layer by paste application and a lower layer by powder molding. As described above, according to the invention, due to the formation of a molded-powder layer as the lower layer (first mixture layer) of an electrode mixture layer, it becomes possible to reduce the resistance which utilizing the merit of the electrode structure. Specifically, it becomes possible to reduce the resistance because the penetrability by electrolytic solutions, orientation of the negative active material, and dispersibility of the positive-electrode conductive material are better than those of single-layer electrodes obtained by paste application, due to the electrode structure of the molded-powder layer constituting the lower layer of the electrode mixture layer.

In addition, due to formation of the upper layer (second mixture layer) of the electrode mixture layer by paste application, the unevenness in mixture-layer loading in the electrode can be made less, i.e. the surface irregularities of the electrode can be made smaller, than that in the case of the molded-powder layer alone, resulting in an improvement in cycling characteristics. Consequently, due to an increase in the range of particle flowability adoptable in the electrode materials for use in powder molding, the electrode mixture layer not only can retain cycling characteristics but also exhibits a higher resistance-reducing effect than the molded-powder layer alone.

According to the invention, due to the formation of a molded-powder layer as the lower layer (first mixture layer) which is a constituent of an electrode mixture layer, improvements are attained in penetrability by electrolytic solutions, orientation of the negative active material, and dispersibility of the positive-electrode conductive material and, hence, the resistance is reduced. Furthermore, due to the formation of a mixture paste layer by paste application as the upper layer (second mixture layer), the unevenness in mixture-layer loading in the electrode can be diminished as compared with the case of the molded-powder layer alone, resulting in an improvement in cycling characteristics. In addition, by making the loading of the mixture layer formed by powder molding larger than that of the mixture paste layer, the amount of the paste to be applied can be reduced and the solvent amount and drying time necessary for paste application can be reduced.

The invention is applicable to secondary-battery electrodes having a configuration which includes a current collector (current collector foil) and an electrode mixture layer (active-material layer) formed on at least one side thereof.

1. An electrode for secondary batteries, the electrode comprising:
a current collector foil;
a first mixture layer that is a layer of granulated particles accumulated on the current collector foil, the granulated particles containing at least a first active material and a first binder; and
a second mixture layer that is a layer of a mixture paste applied to a surface of the first mixture layer and then dried, the mixture paste being obtained by kneading at least a second active material, a second binder, and a solvent.

2. The electrode according to claim 1, wherein a loading of the first mixture layer is larger than a loading of the second mixture layer.
